(19) United States
(12) Patent Application Publication
(10) Pub. No.: US 2023/0223723 A1
(43) Pub. Date: Jul. 13, 2023

(54) ELECTRICAL CONNECTOR HAVING INSERT MOLDED OUTER SHELL WITH A FURTHER INWARD GUIDING END

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: MING-CHING CHEN, New Taipei (TW)

(21) Appl. No.: 18/153,349

(22) Filed: Jan. 11, 2023

(30) Foreign Application Priority Data
Jan. 13, 2022 (CN) 202220085738.2

(51) Int. Cl. H01R 24/38; H01R 13/516; H01R 13/504; H01R 13/629

(52) U.S. Cl. CPC H01R 24/38; H01R 13/516; H01R 13/504; H01R 13/629; H01R 2103/00

(57) ABSTRACT

An electrical connector includes: an insulative base; a center contact secured to the insulative base and extending upward out of the insulative base; and an outer shell secured to the insulative base and extending upward out of the insulative base beyond the center contact, the outer shell having a lower cylindrical part and an upper guiding part, wherein the center contact and the outer shell are insert-molded with the insulative base, the guiding part of the outer shell has an upper free end located inwardly of an interior wall of the lower cylindrical part in a top view, and the insulative base has a through hole encompassing the upper free end of the guiding part in a top view.

### BACKGROUND OF THE INVENTION

### 1. Field of the Invention

The present invention relates to an electrical connector having an insulative base, a center contact secured to the insulative base and extending upward out of the insulative base, and an outer shell secured to the insulative base and extending upward out of the insulative base beyond the center contact, the outer shell having a lower cylindrical part and an upper guiding part, wherein the center contact and the outer shell are insert-molded with the insulative base.

### 2. Description of Related Art

China Patent No. 208240911 discloses an electrical connector including an insulative base, a center contact, and an outer shell, wherein each of the center contact and the outer shell is separately mounted to the insulative base.

U.S. Patent Application Publication No. 2020/0099168 discloses a module side connector having a mating side inner conducting member and a mating side outer conducting member insert molded with an insulative base, wherein the mating side outer conducting member has an outwardly tapered portion. U.S. Pat. No. 9,236,670 discloses an electrical connector including an insulator, an inner conductor, and an outer conductor, wherein the inner conductor and the outer conductor are insert-molded with the insulator but the outer conductor is required to be so shaped to have a tube-shaped portion in order to allow the insert-molding operation.

### SUMMARY OF THE INVENTION

An electrical connector comprises: an insulative base; a center contact secured to the insulative base and extending upward out of the insulative base; and an outer shell secured to the insulative base and extending upward out of the insulative base beyond the center contact, the outer shell having a lower cylindrical part and an upper guiding part, wherein the center contact and the outer shell are insert-molded with the insulative base, the guiding part of the outer shell has an upper free end located inwardly of an interior wall of the lower cylindrical part in a top view, and the insulative base has a through hole encompassing the upper free end of the guiding part in a top view.

### BRIEF DESCRIPTION OF THE DRAWINGS

FIG. 1 is a perspective view of an electrical connector in accordance with the present invention;

FIG. 2 is another perspective view of the electrical connector;

FIG. 3 is a side view of the electrical connector;

FIG. 4 is a top view of the electrical connector;

FIG. 5 is a bottom view of the electrical connector;

FIG. 6 is an exploded view of the electrical connector;

FIG. 7 is another exploded view of the electrical connector; and

FIG. 8 is a cross-sectional view of the electrical connector taken along line A-A in FIG. 1.

### DETAILED DESCRIPTION OF THE PREFERRED EMBODIMENT

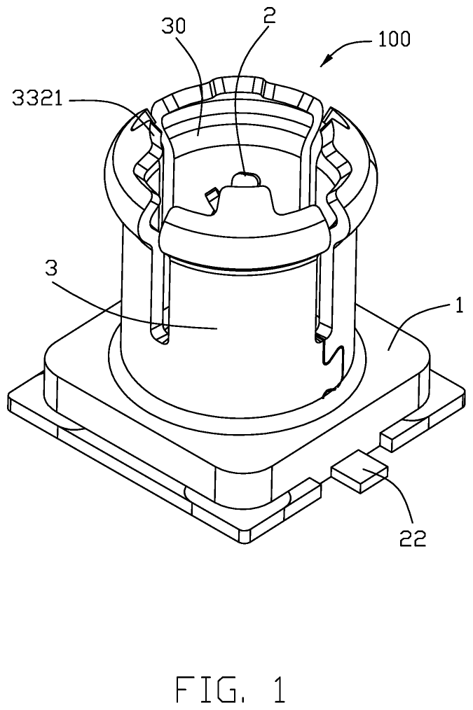

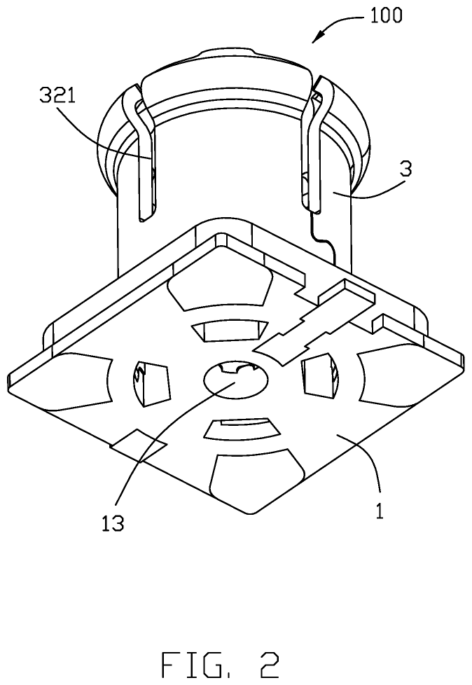

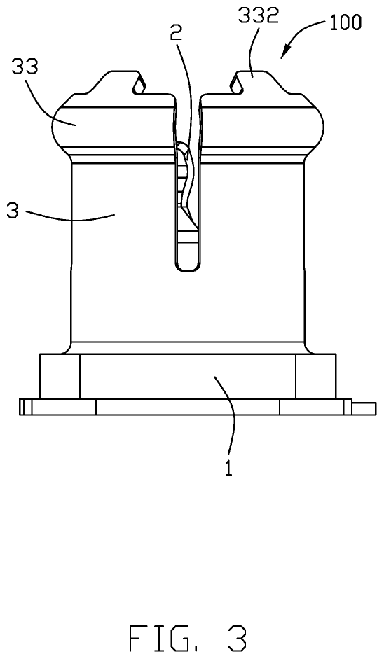

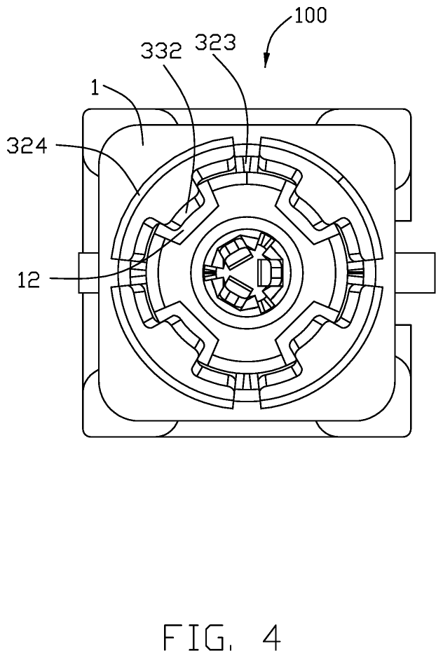

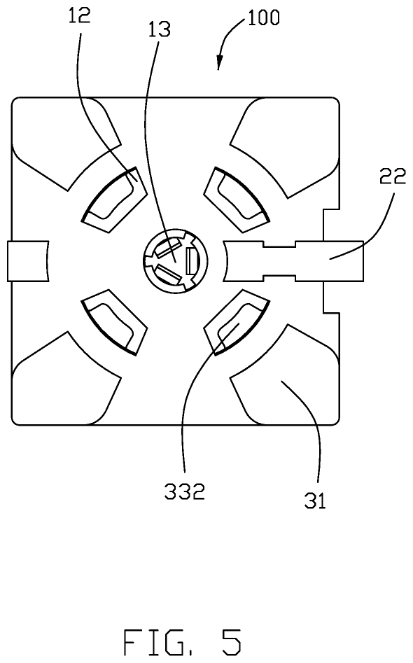

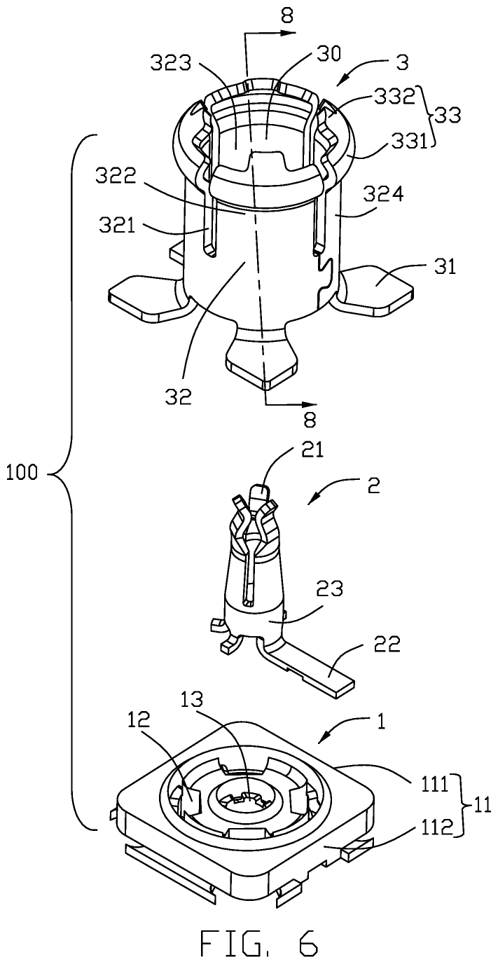

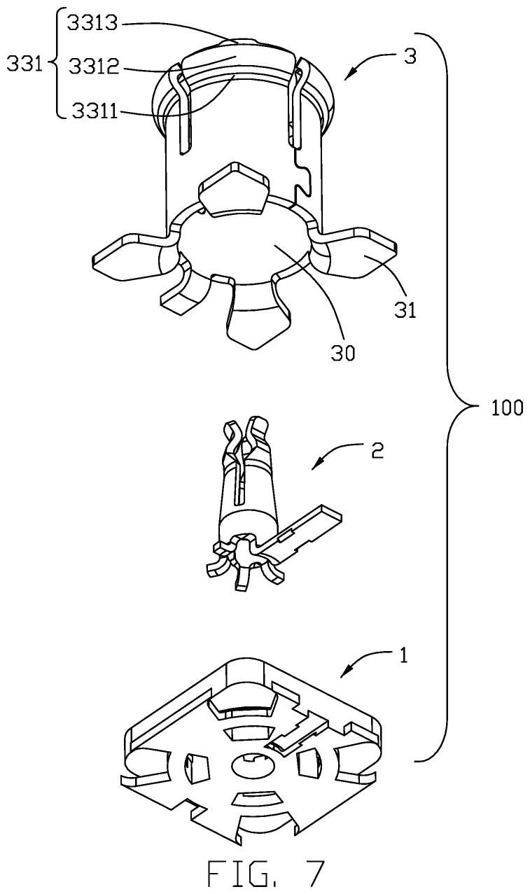

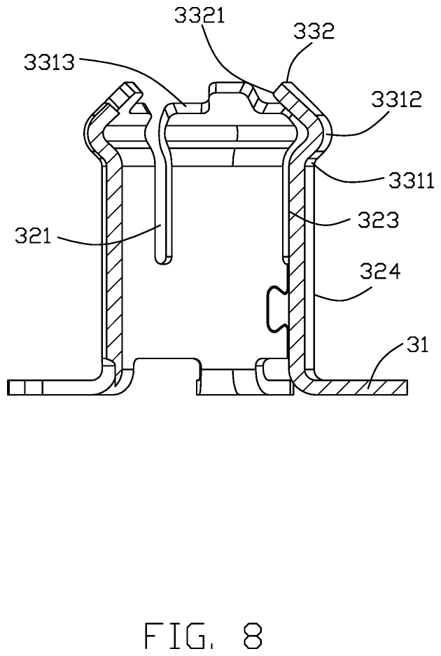

Referring to FIGS. 1-8, an electrical connector 100 includes an insulative base 1, a center contact 2 secured to the insulative base and extending upward out of the insulative base 1, and an outer shell 3 secured to the insulative base 1 and extending upward out of the insulative base 1 beyond the center contact 2. The outer shell 3 has a lower cylindrical part 32 and an upper guiding part 33. The outer shell 3 encloses the insulative base 1 and the center contact 2 to form a receiving space 30. The insulative base 1 is generally rectangular and has a periphery 11, plural through holes 12 (four in this embodiment) inwardly of the periphery 11, and a center cavity 13. The center contact 2 and the outer shell 3 are insert-molded with the insulative base 1. The upper guiding part 33 of the outer shell 3 has an upper free end 332 located inwardly of an interior wall 323 of the lower cylindrical part 32 in a top view. By extending the upper free end 332 further inwardly, a better guiding and mating function may be achieved. The through hole 12 of the insulative base 1 is sized and shaped to encompass, as viewed from a top, the upper free end 332 of the guiding part 33 so that the outer shell 3 with the extended upper free end 332 may still be insert-molded with the insulative base 1.

The center contact 2 has a leg 22, a contacting portion 21, and a connecting portion 23. The outer shell 3 is generally cylindrical and has a leg 31 constructed of four portions in this embodiment. The cylindrical part 32 of the outer shell 3 includes four equidistantly spaced upper spring arms 322 and has the interior wall 323 and an exterior wall 324. A tip 3321 of the upper guiding part free end 332 is located closer to the center contact 2 than the cylindrical part interior wall 323. A gap 321 is formed between every two adjacent spring arms 322.

The guiding part 33 of the outer shell 3 has plural guiding portions corresponding to the upper spring arms 322. Each guiding portion includes a first section 331 continuing an associated spring arm 322 and a second section, i.e., the upper free end 332, inwardly continuing the first section 331. The first section 331 includes a connecting wall 3311, a guiding wall 3312 upwardly and outwardly continuing the connecting wall 3311, and a top wall 3313 upwardly continuing the guiding wall 3312. An inner tip of the top wall 3313 is substantially aligned in a vertical direction with the interior wall 323 of the outer shell cylindrical part 32. The guiding wall 3312 bulges outward relative to the spring arm 322 and has an outer dimension of approximately 3.39 mm in this embodiment, while the outer shell cylindrical part 32 has an outer dimension of about 2.92 mm.

The upper free end 332 has a circumferential dimension less than that of the first section 331 and extends upwardly and inwardly therefrom at approximately a middle thereof. The through hole 12 is substantially vertically aligned with the upper free end 332 and is so designed to encompass the upper free end of the guiding part in a top view. This design makes an insert-molding process of the outer shell 3 (having the extended upper free end 332) and the insulative base 1 feasible.

Since the tip 3321 of the upper guiding part free end 332 is located further inwardly, a mating tolerance of the electrical connector 100 with a complementary connector is improved. Design of plural spring arms 322 as well as smaller circumferential dimension for the upper free end 332 than the first section 331 in the electrical connector 100 is advantageous for insert-molded outer shell 3 and insulative base 1.

1. An electrical connector comprising:
an insulative base;
a center contact secured to the insulative base and extending upward out of the insulative base; and
an outer shell secured to the insulative base and extending upward out of the insulative base beyond the center contact, the outer shell having a lower cylindrical part and an upper guiding part; wherein
the center contact and the outer shell are insert-molded with the insulative base;
the guiding part of the outer shell has an upper free end located inwardly of an interior wall of the lower cylindrical part in a top view; and
the insulative base has a through hole encompassing the upper free end of the guiding part in a top view.

2. The electrical connector as claimed in claim 1, wherein the cylindrical part of the outer shell comprises a plurality of upper spring arms, and the guiding part of the outer shell comprises a plurality of guiding portions corresponding to the plurality of upper spring arms.

3. The electrical connector as claimed in claim 1, wherein the upper free end of the guiding part has a circumferential dimension less than that of a remaining portion of the guiding part.

4. An electrical connector comprising:
an insulative base;
a center contact secured to the insulative base and extending upward out of the insulative base; and
an outer shell secured to the insulative base and extending upward out of the insulative base beyond the center contact, the outer shell has a plurality of spring arms and a plurality of guiding portions extending upward from corresponding spring arms; wherein
the center contact and the outer shell are insert-molded with the insulative base;
each guiding portion of the outer shell has an upper free end located inwardly of an interior wall of an associated spring arm in a top view; and
the insulative base has a plurality of through holes each encompassing the upper free end of an associated guiding portion in a top view.

5. The electrical connector as claimed in claim 4, wherein each guiding portion has a lower section and the upper free end upwardly continues the lower section, and the lower section has a top wall with an inner tip substantially vertically aligned with the interior wall of an associated spring arm.
